(19) United States
(12) Patent Application Publication
(10) Pub. No.: US 2026/0141546 A1
(43) Pub. Date: May 21, 2026

(54) THREE-DIMENSIONAL MEASUREMENT SYSTEM, THREE-DIMENSIONAL MEASUREMENT METHOD, AND THREE-DIMENSIONAL MEASUREMENT PROGRAM

(71) Applicant: KONICA MINOLTA, INC., TOKYO (JP)

(72) Inventors: Yasuyuki KAMAI, Tokyo (JP); Makoto OOKI, Toyohashi-shi (JP); Tomoyoshi YUKIMOTO, Tokyo (JP); Akihiro NAKAMURA, Tokyo (JP); Katsunori TAKAHASHI, Tokyo (JP)

(21) Appl. No.: 19/393,718

(22) Filed: Nov. 19, 2025

(30) Foreign Application Priority Data
Nov. 19, 2024 (JP) 2024-201367

(51) Int. Cl. G06T 7/50; G06T 7/11; G06T 7/20; G06T 7/60; G06V 10/145; G06V 10/60; G06V 10/74

(52) U.S. Cl. CPC G06T 7/50; G06T 7/11; G06T 7/20; G06T 7/60; G06V 10/145; G06V 10/60; G06V 10/761; G06V 2201/07

(57) ABSTRACT

A three-dimensional measurement system includes an irradiation region division section that divides an irradiation region into two or more regions and irradiates each of the two or more regions with irradiation light in a different pattern, an imaging region division section that divides an imaging region into two or more regions, a region association section that associates a divided region in the imaging region with a corresponding region obtained by division of the irradiation region, an allocation section that allocates one measurement method from among measurement methods to each of divided regions in the imaging region, the divided regions each being associated with a corresponding one of regions obtained by division of the irradiation region, and a shape measurement calculation section that measures a shape of each of target workpieces by a measurement method allocated to a corresponding one of the divided regions in the imaging region.

### CROSS-REFERENCE STATEMENT

The present invention claims priority under 35 U.S.C. § 119 to Japanese Patent Application Number 2024-201367, filed Nov. 19, 2024, the disclosure of which is hereby incorporated by reference herein in its entirety.

### BACKGROUND OF THE INVENTION

### Technical Field

The present invention relates to a three-dimensional measurement system, three-dimensional measurement method, and a non-transitory computer-readable storage medium storing a program.

### Description of Related Art

At production sites of various products, various articles may be in a static state such as randomly piled or a flat pile. In addition, various articles may be in a state of being conveyed by a belt conveyor or the like. At the production site, the shape of the article is measured by three-dimensional measurement using triangulation as a principle. Note that the various articles are components and the like. At such a production site, the state of the article includes a stationary state and a conveyance state. An optimal method for shape recognition is different between the former and the latter in shape measurement of an object. For example, a phase shift method or the like is suitable for shape measurement of an article in a stationary state. On the other hand, a light section method or the like is suitable for shape measurement of an article in a conveyed state. From such a viewpoint, it has been proposed to apply different measurement methods to shape measurement of an article in a stationary state and shape measurement of an article in a conveyance state. See, for example, Japanese Unexamined Patent Publication Number 2018-146521 (hereinafter “Patent Literature 1”). Patent Literature 1 describes switching between a first camera and a second camera in accordance with a distance to a target workpiece. Then, in Patent Literature 1, one of shape measurement methods is applied.

### SUMMARY OF THE INVENTION

Patent Literature 1 discloses a conventional technique. However, as a conventional technology, it is desired to suitably perform shape measurement of a target workpiece even under an environment in which production forms are aggregated and mixed. This is explained below.

In recent years, with a change in production method, it has been required to construct an optimal production system each time at a production site in order to cope with a wide variety of products in small quantities and a variety of variables. In addition, automation by robots is progressing in the conveyance and inspection of intermediate in-process parts. However, in some cases, target workpieces are randomly piled in a conveyance container such as a bucket. In some cases, it is continuously conveyed by using a belt conveyor. Therefore, the production system changes in various ways.

As a measurement method, known methods exist. The multiple known methods include a phase shift method, a light section method, a spatial encoding method, and the like. These measurement methods have various characteristics. Therefore, it is preferable to use them properly according to a situation. However, the conventional technique disclosed in Patent Literature 1 applies only one measurement method to an image captured by one camera. The captured image is from one camera angle of view. Therefore, in the related art, it is not possible to selectively use an arbitrary measurement method according to a situation. That is, in the related art, it is not possible to switch types of measurement methods particularly for each region in response to a production system that changes in various ways. In the conventional technology, shape measurement of a target workpiece may be executed by using different measurement methods. In such a case, it is necessary to prepare images captured by cameras. The images are images of camera angles of view.

In addition, from the viewpoint of a space of a production site, integration of production processes and efficiency of an occupied area are required. Under such circumstances, it is conceivable to prepare respective facilities for shape measurements of target workpiece. However, this is not reasonable in terms of efficiency and cost. If possible, a general-purpose system is required.

The present invention has been made in response to the above-described problems of the conventional art. Production forms may be aggregated and mixed. An object of the present invention is to provide a three-dimensional measurement system, a three-dimensional measurement method, and a non-transitory computer-readable storage medium storing a program storing a program, which are capable of suitably measuring the shape of a target workpiece even under such an environment.

The above problems are solved by the following means.

To achieve at least one of the abovementioned objects, according to an aspect of the present invention, a three-dimensional measurement system to measure a three-dimensional shape of a target workpiece by capturing an irradiation region which is irradiated in a predetermined pattern and has a predetermined area by a two-dimensional light-receiving sensor. The three-dimensional measurement system includes an irradiation region division section that divides the irradiation region into two or more regions and irradiates each of the two or more regions with irradiation light in a different pattern, an imaging region division section that divides an imaging region into two or more regions, a region association section that associates a divided region in the imaging region with a corresponding region obtained by division of the irradiation region, an allocation section that allocates one measurement method from among measurement methods to each of divided regions in the imaging region, the divided regions each being associated with a corresponding one of regions obtained by division of the irradiation region, and a shape measurement calculation section that measures a shape of each of target workpieces by a measurement method allocated to a corresponding one of the divided regions in the imaging region.

### BRIEF DESCRIPTION OF THE DRAWINGS

Advantages and features provided by one or more embodiments of the invention will become more fully understood from the detailed description given hereinbelow and the appended drawings which are given by way of illustration only, and thus are not intended as a definition of the limits of the present invention.

FIG. 1 is a configuration block diagram of a three-dimensional measurement system according to an embodiment.

FIG. 2 is a schematic explanatory diagram of operation of the three-dimensional measurement system according to the embodiment.

FIG. 3A is an illustration of division of an irradiation region.

FIG. 3B is an illustration of division of an irradiation region.

FIG. 4A is an explanatory diagram 1 of association of divided regions.

FIG. 4B is an explanatory diagram 2 of association of divided regions.

FIG. 4C is an explanatory diagram 3 of association of divided regions.

FIG. 5 is an explanatory diagram of a measurement method.

FIG. 6A is an operation explanatory diagram 1 in the case where one camera can cope with.

FIG. 6B is an operation explanatory diagram 2 in the case where one camera can cope with.

FIG. 7A is an operation explanatory diagram 1 in the case where one camera cannot cope with.

FIG. 7B is a diagram 2 for explaining an operation in the case where one camera cannot cope with.

FIG. 8A is an explanatory diagram of an irradiation region in the case where an interference prevention region is not provided.

FIG. 8B is an explanatory diagram of an irradiation region in the case where an interference prevention region is provided.

FIG. 9A is an explanatory diagram 1 of the positions of a projector and a camera with respect to a target workpiece. The projector is a light source.

FIG. 9B is an explanatory diagram 2 of the positions of a projector and a camera with respect to a target workpiece. The projector is a light source.

FIG. 10A is an explanatory diagram 1 of the orientation of a projector. The projector is a light source.

FIG. 10B is an explanatory diagram 2 of the orientation of a projector. The projector is a light source.

FIG. 11A is an illustration 1 of a shadow region.

FIG. 11B is an illustration 2 of a shadow region.

FIG. 12 is an explanatory diagram of a relationship between a shadow region and a margin.

FIG. 13A is an explanatory diagram 1 of a relationship between the direction of a projector and a shadow area. The projector is a light source.

FIG. 13B is an explanatory diagram 2 of a relationship between the direction of the projector and the shadow area. The projector is a light source.

FIG. 14 is a flowchart of a schematic operation of an entire three-dimensional measurement system.

FIG. 15 is a flowchart of an operation of determining a camera angle of view in a three-dimensional measurement system.

FIG. 16 is a flowchart of an operation of determining divided regions in a three-dimensional measurement system.

FIG. 17 is a flowchart of a measurement method allocation operation in a three-dimensional measurement system.

FIG. 18 is a flowchart of a shape measurement operation in the three-dimensional measurement system.

FIG. 19 is a flowchart of a post-processing operation in a three-dimensional measurement system.

### DETAILED DESCRIPTION

Hereinafter, one or more embodiments of the present invention will be described with reference to the drawings. However, the scope of the invention is not limited to the disclosed embodiments.

In the following, embodiments of the present invention will be described in detail with reference to the drawings. Note that the drawings are schematically illustrated to such an extent that the present invention can be fully understood. Therefore, the present invention is not limited to only the examples illustrated in the drawings. Furthermore, common constituent elements and similar constituent elements have the same reference numerals in the respective drawings. A redundant description thereof will be omitted.

### Configuration of Three-Dimensional Measurement System

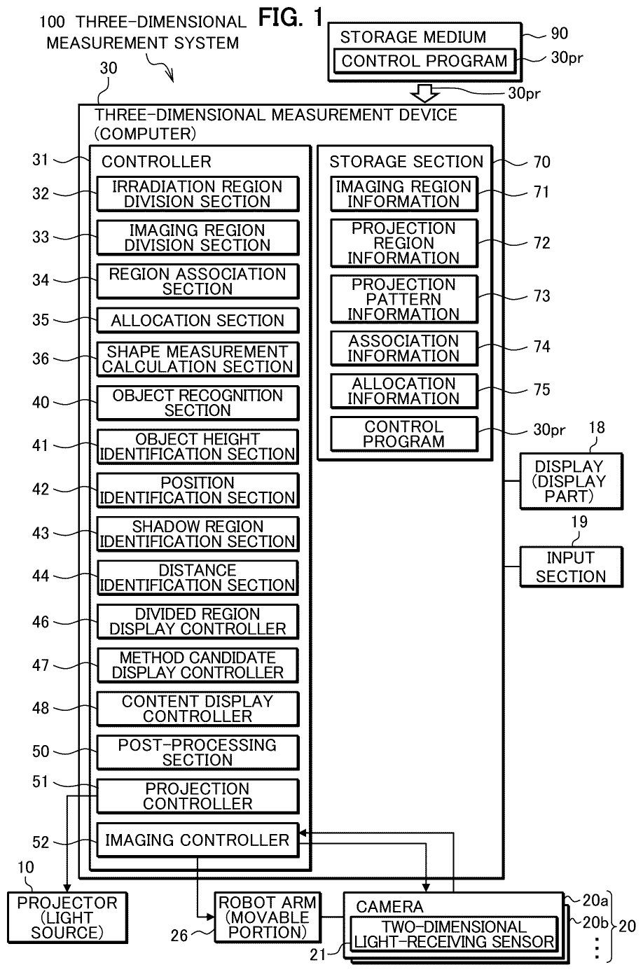

Hereinafter, FIG. 1 will be referred to. Next, a configuration of a three-dimensional measurement system 100 according to the present embodiment will be described. FIG. 1 is a configuration block diagram of the three-dimensional measurement system 100 according to the present embodiment.

The three-dimensional measurement system 100 is an active 3D vision system. The three-dimensional measurement system 100 includes a projector and a two-dimensional light-receiving sensor. The three-dimensional measurement system 100 divides a two-dimensional irradiation region. The three-dimensional measurement system 100 divides an imaging region. Then, the three-dimensional measurement system 100 responds to a state such as a standstill or a movement of a target workpiece as a workpiece to be measured, a variation or a difference in work distance, and the like. In response to these, the three-dimensional measurement system 100 can use different measurement methods at the same time. The different measurement methods include a phase shift method and a light section method. Note that here, a work distance between a camera and a target workpiece is a height of the camera.

As shown in FIG. 1, the three-dimensional measurement system 100 according to the present embodiment includes a projector 10, a camera 20, and a three-dimensional measurement device 30. The three-dimensional measurement device 30 is configured with a computer.

The projector 10 is a light source. The projector 10 emits projector light. A light source may not be the projector 10. A light source may be configured with a laser oscillator. A laser oscillator emits laser light.

The camera 20 is an imaging unit. Imaging means captures an image of a target workpiece. The camera 20 includes a built-in two-dimensional light-receiving sensor 21. The two-dimensional light-receiving sensor 21 receives light and generates an electric signal. The camera 20 captures light with the two-dimensional light-receiving sensor 21 to acquire luminance information of a target workpiece and the periphery thereof. Light is projected from the projector 10. The projector 10 is a light source. In the description of the present embodiment, the three-dimensional measurement system 100 includes a first camera 20a for short range and a second camera 20b for long range. Provided that the three-dimensional measurement system 100 can include another camera 20. Each camera 20 is supported by a robot arm 26. The robot arm 26 directs the optical axis of each camera 20 in any direction. Thus, the robot arm 26 functions as a movable portion. The movable portion changes a imaging position.

The three-dimensional measurement device 30 measures the three-dimensional shape and dimension of a target workpiece. The three-dimensional measurement device 30 is configured with a computer. The three-dimensional measurement device 30 includes a controller 31 and a storage section 70. A display 18 and an input section 19 are connected to the three-dimensional measurement device 30. The display 18 is a display part. The input section 19 is an input device. The input device is a keyboard, a mouse, or the like. The input section 19 accepts a user's instruction. In response to an instruction from a user through the input section 19, an irradiation region division section 32 and an imaging region division section 33 determine divided regions. Note that the irradiation region division section 32 and the imaging region division section 33 can identify the divided regions in the irradiation region and the imaging region according to a recognition result by an object recognition section 40.

The controller 31 controls the operation of the entire three-dimensional measurement device 30. The control program 30pr is stored in the storage section 70. The controller 31 executes the control program 30pr. As a result, for example, each functional unit is constructed as illustrated in FIG. 1. In the example of FIG. 1, the controller 31 includes the irradiation region division section 32, the imaging region division section 33, a region association section 34, an allocation section 35, and a shape measurement calculation section 36. The controller 31 also includes the object recognition section 40, an object height identification section 41, a position identification section 42, a shadow region identification section 43, a distance identification section 44, a divided region display controller 46, a method candidate display controller 47, and a content display controller 48. The controller 31 includes a post-processing section 50, a projection controller 51, and an imaging controller 52. However, it is possible to delete some of these constituent elements.

The irradiation region division section 32 generates a projection pattern. The projection pattern is projected onto an irradiation region. The irradiation region division section 32 functions as an irradiation region division section. The irradiation region division section divides the irradiation region into two or more regions. The imaging region division section 33 selects a shape measurement method. The imaging region division section 33 divides a imaging region into two or more.

The divided regions of the irradiation region correspond to the divided regions of the imaging region. The region association section 34 associates corresponding divided regions with each other. That is, the divided regions in the irradiation region and the divided regions in the imaging region corresponding to the divided regions in the irradiation region are associated with each other. The allocation section 35 allocates one of measurement methods to each of the associated divided regions. The shape measurement calculation section 36 measures the shape of each of target workpieces in accordance with a measurement method allocated to a corresponding one of the divided regions.

The object recognition section 40 recognizes a target object. The target object is shown in a acquired image. The object height identification section 41 determines the heights of target objects. The target objects are within the same angle of view.

The position identification section 42 identifies a relative position between irradiation light and a boundary between divided regions. The shadow region identification section 43 identifies a shadow area in a divided region. This divided region is adjacent to the divided region and is relatively far in height. The distance identification section 44 determines a physical distance between objects. The objects exist within the same angle of view. The divided region display controller 46 displays a divided region on the display 18 in an identifiable manner.

The method candidate display controller 47 displays a candidate of a shape measurement method on the display 18 in an identifiable manner. The content display controller 48 displays the content of stored information on the display 18. The storage information is stored in the storage section 70. The stored information includes association information 74 and allocation information 75.

The post-processing section 50 performs post-processing. The post-processing is illustrated in FIG. 19. The post-processing will be described later. The projection controller 51 controls an operation of the projector 10. The imaging controller 52 controls an operation of the camera 20 and the robot arm 26.

The storage section 70 stores information such as imaging region information 71, projection region information 72, projection pattern information 73, the association information 74, and the allocation information 75.

The imaging region information 71 relates to an imaging region of the camera 20. The projection region information 72 relates to an imaging region of a projection pattern. The projection pattern is projected from the projector 10. The projection pattern information 73 relates to a projection pattern to be projected from the projector 10. The projection pattern is projected from the projector 10. The association information 74 represents a correspondence relationship between a divided region in a associated irradiation region and a divided region in an associated imaging region. The allocation information 75 indicates the type of an allocated measurement method from among measurement methods for each associated divided region.

The storage section 70 stores a program. The program is the control program 30pr or the like. The control program 30pr causes a computer to function as the three-dimensional measurement device 30. The control program 30pr is stored in a storage medium 90 or the like. The control program 30pr is installed in the computer directly or indirectly from the storage medium 90. The control program 30pr causes a computer to function as the three-dimensional measurement device 30.

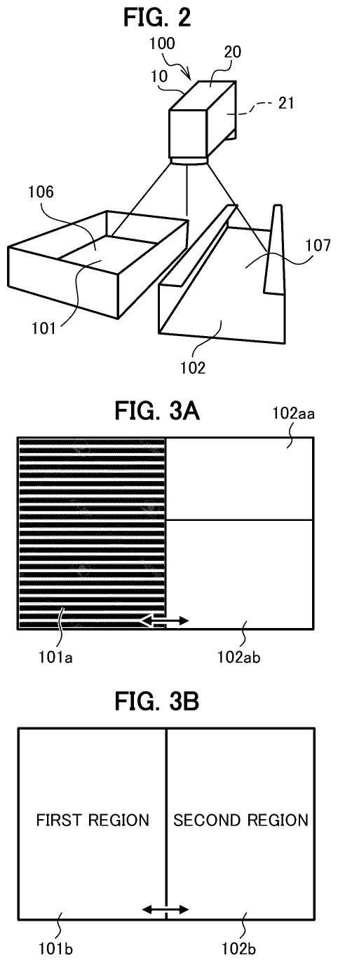

FIG. 2 is a schematic explanatory diagram of an operation of the three-dimensional measurement system 100. As illustrated in FIG. 2, the three-dimensional measurement system 100 divides each of a two-dimensional irradiation region and imaging region into divide regions. The three-dimensional measurement system 100 associates the divided regions in the irradiation region with the divided regions in the imaging region. Then, the three-dimensional measurement system 100 responds to the stationary or moving state of a target workpiece, a fluctuation or difference in work distance a which is from a camera to a target workpiece, and the like. In response to these, the three-dimensional measurement system 100 allocates two or more different measurement methods to respective ones of the divided regions in the imaging region. For example, two or more different measurement methods include a phase shift method, a light section method, and the like. Thereafter, the three-dimensional measurement system 100 irradiates a target workpiece with a projection pattern. Thus, the three-dimensional measurement system 100 acquires a two-dimensional image of the target workpiece. Each of projection patterns corresponds to a corresponding one of the divided regions. Then, the three-dimensional measurement system 100 measures the shape of the target workpiece based on the target workpiece two-dimensional image using a measurement method. Thus, the three-dimensional measurement system 100 acquires a three-dimensional restored image of the target workpiece. A measurement method is allocated to each of the divided regions in the imaging region. The irradiation takes place as a projection.

In such a configuration, the irradiation region division section 32 synthesizes and generates a projection pattern necessary for each of the divided regions in the irradiation region based on information. The information is held in the storage section 70. The projection controller 51 controls optical means. Then, the projection controller 51 irradiates the target workpiece with the light of a projection pattern. The optical means includes the projector 10 or the like. The projection pattern is generated by the irradiation region division section 32. The irradiation takes place as a projection. The imaging controller 52 acquires a two-dimensional image. The two-dimensional light-receiving sensor 21 is built in the camera 20. Two-dimensional image is formed on the two-dimensional light-receiving sensor 21. At that time, the projection controller 51 and the imaging controller 52 operate in a synchronized and coordinated manner. The purpose of this is to synchronize the timing of light emission and light reception. The irradiation takes place as a projection.

The imaging region division section 33 selects an allocated measurement method for each of the divided regions in the imaging region. Signals and images are obtained from the camera 20. The divided regions in the imaging region are held in the storage section 70. The shape measurement calculation section 36 uses a measurement method. Then, the shape measurement calculation section 36 measures the shape of the target workpiece based on two-dimensional image of the target workpiece. Next, the shape measurement calculation section 36 acquires a three-dimensional restored image of the target workpiece. A measurement method is allocated to each of the divided regions of the imaging region.

In the related art described in Patent Literature 1, only one measurement method is applied to an image of one camera angle of view which is captured by one camera. In the conventional technology described in Patent Literature 1, shape measurements of target workpieces may be executed using different measurement methods. In that case, it is necessary to prepare images at camera angles of view which are captured by cameras. On the other hand, the three-dimensional measurement system 100 according to the present embodiment divides an image of one camera angle of view which is captured by one camera into divided regions. As a result, the three-dimensional measurement system 100 according to the present embodiment measures the shapes of target workpieces as if based on images of camera angles of view captured by cameras.

FIG. 3A and FIG. 3B are each an illustration of division of an irradiation region. FIG. 3A illustrates an example of division of an irradiation pattern. FIG. 3B illustrates an example of light-receiving side processing. In the example of FIG. 3A, in divided irradiation regions, an irradiation pattern differs between a first region 101a on the left side and second regions 102aa and 102ab on the right side. Further, in an example shown in FIG. 3B, a shape measurement by the phase shift method is performed in a first region 101b on the left side in the divided imaging region. A shape measurement by the light section method is performed in a second region 102b on the right side. Note that the phase shift method and the light section method are known measurement methods. Therefore, the detailed descriptions of the phase shift method and the light section method are omitted here.

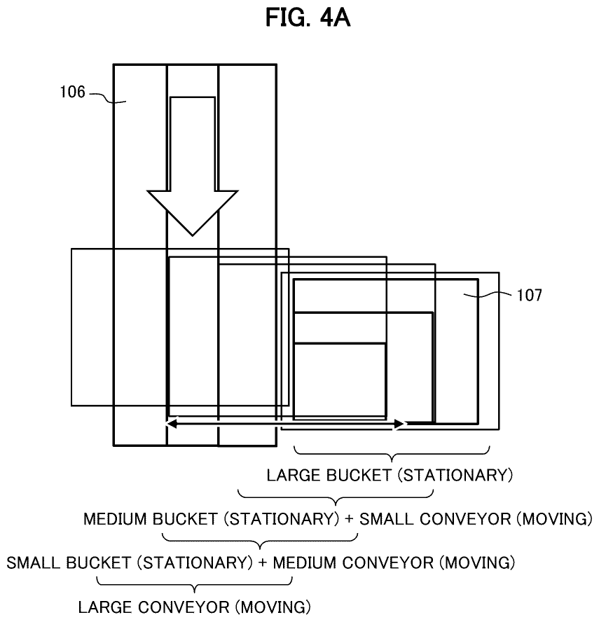

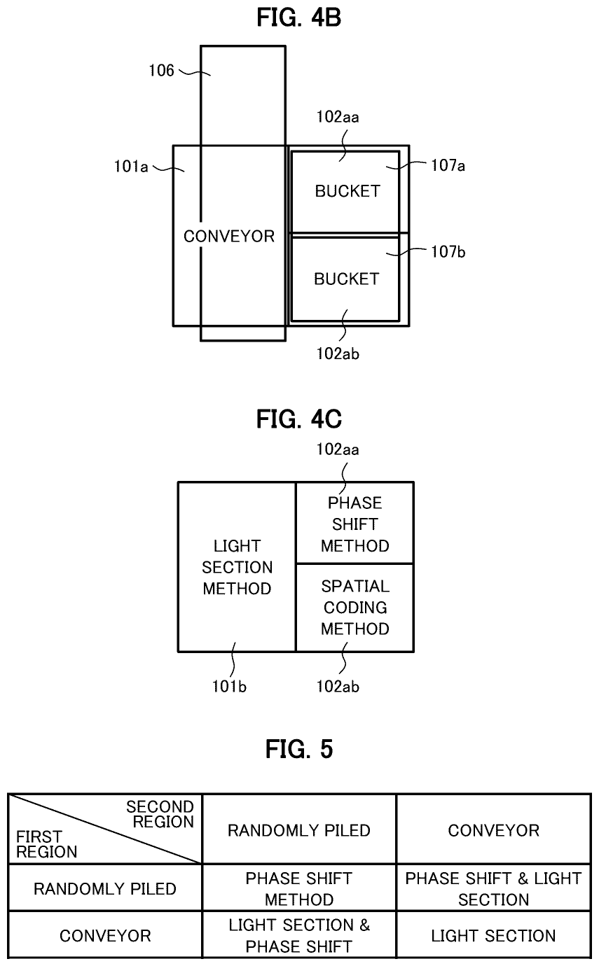

FIG. 4A, FIG. 4B, and FIG. 4C are each an illustration of association of divided regions. FIG. 4A shows an example in which one belt conveyor 106 and one bucket 107 are divided into N sections. The bucket 107 is a container transported by the belt conveyor 106. FIG. 4A shows differences in size between the belt conveyor 106 and the bucket 107, and classification patterns of the belt conveyor 106 and the bucket 107. The classification patterns are classified according to differences in moving states or stationary states of the belt conveyor 106 and the bucket 107. Note that in FIG. 4A, a hollow arrow indicates a conveyance direction of the belt conveyor 106. The three-dimensional measurement system 100 changes the allocation of vision's field of view according to the configuration of a facility. The three-dimensional measurement system 100 may take an image from above. The three-dimensional measurement system 100 determines an angle of view in that case. An irradiation region and an imaging region may be divided into N segments. FIG. 4B shows an example of such a case. In the example of FIG. 4B, an irradiation region and an imaging region are divided. One first region 101a is on the left side. The first region 101a corresponds to one belt conveyor 106. Two second regions 102aa, 102ab are on the right. The two second regions 102aa and 102ab correspond to two buckets 107a and 107b. Note that a division method is not limited to the example illustrated in FIG. 4B. The number of N divisions may be arbitrary. For the three-dimensional measurement system 100, division based on a optimal measurement method for each region is desirable. A measurement method may be allocated to each divided region. An example of such a case is illustrated in FIG. 4C. In the example of FIG. 4C, a light section method is allocated to the first region 101a. A phase shift method and a spatial coding method are allocated to the second regions 102aa and 102ab relatively.

FIG. 5 is an explanatory diagram of a measurement method. In a first region and a second region, target workpieces may be randomly piled or on a belt conveyor. An example of allocation of measurement methods in each combination in these cases is illustrated in FIG. 5.

In the three-dimensional measurement system 100, region division is performed manually or automatically. In the case of a manual operation, an user designates a predetermined number of division and division sizes to the three-dimensional measurement device 30. On the other hand, in the case of automatic recognition, the three-dimensional measurement device 30 recognizes an object. The object is in the captured image of the camera 20. Then, the three-dimensional measurement device 30 automatically determines a region for the belt conveyor 106 and the region of the bucket 107.

The three-dimensional measurement system 100 allocates a measurement method to each divided region. The three-dimensional measurement system 100 can perform this allocation manually or automatically. In a case of a manual operation, a user specifies a measurement method for each divided region to the three-dimensional measurement device 30. On the other hand, in a case of an automatic operation, each divided region and a measurement method to be used are associated with each other in advance. The three-dimensional measurement device 30 automatically allocates a measurement method to each divided region in accordance with the attribute of each divided region.

The three-dimensional measurement system 100 may include one camera 20. Examples of such a case are illustrated in FIG. 2 to FIG. 5. However, the three-dimensional measurement system 100 may include two cameras 20. Even in this case, the present invention can be applied. In this case, regarding a difference or a change in work distance, in addition to division of a region, the first camera 20a and the second camera 20b are switched according to the accuracy of a measurement or the presence or absence of a change in work distance. At this time, in the three-dimensional measurement system 100, it is desirable to define a relationship between each divided region and the first camera 20a or the second camera 20b corresponding to each divided region in accordance with positions or the like of the target workpieces. A difference or change in work distance changes depending on the height of the camera 20.

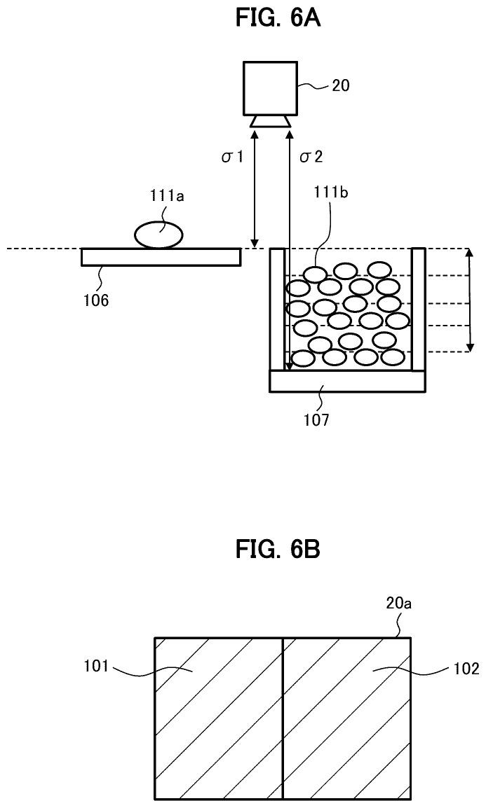

FIG. 6A and FIG. 6B are explanatory diagrams of an operation in a case where one camera 20 can handle a process. There is a case where one camera 20 can handle a process. An example of such a case is illustrated in FIG. 6A and FIG. 6B. In FIG. 6A and FIG. 6B, a difference between a work distance on the right side and a work distance on the left side is small. The work distance on the right side is a work distance between the camera 20 and a target workpiece 111b. The work distance on the left side is a work distance between the camera 20 and a target workpiece 111a. To be specific, on the left side of FIG. 6A, the target workpiece 111a is placed on the belt conveyor 106. On the right side of FIG. 6A, the top portion of the bucket 107 is disposed at the same height as the upper surface of the belt conveyor 106. The target workpiece 111b is placed in the bucket 107. The FIG. 6B shows that an imaging region is divided into a first region 101 and a second region 102. The imaging region is the image captured by the first camera 20a for short range. The first region 101 corresponds to the left side of FIG. 6A. The second region 102 corresponds to the right side of FIG. 6A. In addition, FIG. 6B shows that a light section method is allocated to the first region 101 and a phase shift method is allocated to the second region 102 as a measurement method. In the example of FIG. 6B, the work distance of the target workpiece 111a in the first region 101 are constant. Therefore, the light section method is allocated to the first region 101 as a measurement method. The light section method is suitable for shape measurement of an object at a certain distance. Further, the work distance of the target workpiece 111b in the second region 102 change. Therefore, the phase shift method is allocated to the second region 102 as a measurement method. The phase shift method is suitable for shape measurement of an object under a condition in which a distance varies. It is assumed that the position of the target workpiece 111a and the position of the target workpiece 111b are as illustrated in FIG. 6A. The target workpiece 111a is disposed on the belt conveyor 106. The target workpiece 111b is located in the bucket 107. In this case, the three-dimensional measurement system 100 measures the shape of each of the target workpieces 111a and 111b based on the images captured by the first camera 20a for short range. At that time, the three-dimensional measurement system 100 measures the shape of each of the target workpieces 111a and 111b by using the allocated measurement methods illustrated in FIG. 6B.

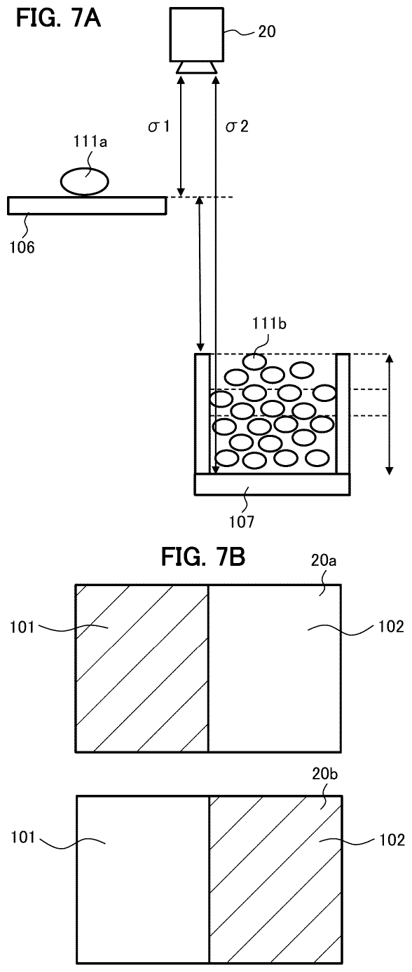

There is a case where one camera may not be able to handle a process. Operation explanatory diagrams in such a case are FIG. 7A and FIG. 7B. In FIG. 7A and FIG. 7B, a difference between a work distance on the left side and a work distance on the right side is large. The work distance on the left is a work distance between the camera 20 and the target workpiece 111a. The work distance on the right is a work distance between the camera 20 and the target workpiece 111b. There is a case where one camera 20 cannot handle a process. An example of such a case is illustrated in FIG. 7A and FIG. 7B. In this case, the three-dimensional measurement system 100 captures images of the target workpieces 111a and 111b in their respective regions by the first camera 20a and the second camera 20b. To be specific, on the left side of FIG. 7A, the target workpiece 111a is placed on the belt conveyor 106. On the right side of FIG. 7B, the top portion of the bucket 107 is disposed at a position lower than the upper surface of the belt conveyor 106. The target workpiece 111b is placed in the bucket 107. The image captured by the first camera 20a for short range is an imaging region. The image captured by the second camera 20b for long range is an imaging region. FIG. 7B illustrates that each captured image is divided into the first region 101 and the second region 102. The first region 101 corresponds to the left side of FIG. 7A. The second region 102 corresponds to the right side of FIG. 7A. In addition, FIG. 7B shows that a light section method is allocated to the first region 101 of the image captured by the first camera 20a and a phase shift method is allocated to the second region 102 of the image captured by the second camera 20b as a measurement method. In the example of FIG. 7B, in the first region 101 of the image captured by the first camera 20a, the work distances of the target workpiece 111a is constant. Therefore, the light section method is allocated to the first region 101 as a measurement method. The light section method is suitable for shape measurement of an object at a certain distance. In addition, in the second region 102 of the image captured by the second camera 20b, the work distances of the target workpiece 111b change. Therefore, the phase shift method is allocated to the second region 102 as a measurement method. The phase shift method is suitable for shape measurement of an object under a condition in which a distance varies. It is assumed that the position of the target workpiece 111a and the position of the target workpiece 111b are as illustrated in FIG. 7A. The target workpiece 111a is disposed on the belt conveyor 106. The target workpiece 111b is located in the bucket 107. In this case, the three-dimensional measurement system 100 measures the shape of each of the target workpieces 111a and 111b based on the image captured by the first camera 20a for short range and the image captured by the second camera 20b for long range. At that time, the three-dimensional measurement system 100 measures the shape of each of the target workpieces 111a and 111b by using the allocated measurement methods illustrated in FIG. 7B.

Note that in addition to the patterns in FIG. 6A and FIG. 6B and the patterns in FIG. 7A and FIG. 7B, a work distance may change during shape measurement. In this case, in the three-dimensional measurement system 100, the image of the camera 20 may be automatically switched. The camera 20 is used for shape measurement.

### Interference Prevention Region

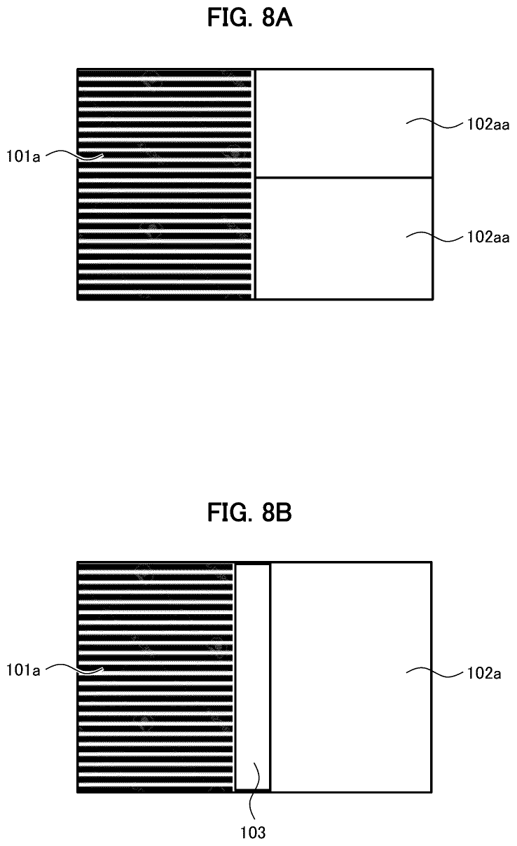

In the three-dimensional measurement system 100, an interference prevention region 103 may be set or changed in a region boundary portion of an arbitrary divided region. There is a case where the interference prevention region 103 may not be provided. An explanatory diagram of an irradiation region in that case is FIG. 8A. There is a case where the interference prevention region 103 may be provided. An explanatory diagram of an irradiation region in that case is FIG. 8B. The interference prevention region 103 is set for a region boundary portion of an arbitrary divided region. The region not irradiated with light is the interference prevention region 103. The irradiation region division section 32 of the three-dimensional measurement system 100 recognizes a work region. The irradiation region division section 32 does not form an irradiation pattern in a certain region of the boundary portion. Such the three-dimensional measurement system 100 changes the setting of the interference prevention region 103. Thus, the three-dimensional measurement system 100 can prevent interference with three-dimensional measurement and calculation of the target workpiece 111 at the region boundary portion between adjacent divided regions. The setting and changing of the interference prevention region 103 may be manually performed. The setting or change of the interference prevention region 103 may be automatically performed. Note that in the case of automatic recognition, the three-dimensional measurement system 100 recognizes a margin in the regions for the belt conveyor 106 and the bucket 107. Next, the three-dimensional measurement system 100 determines the interference prevention region 103.

Position of Projector as Light Source and Camera with Respect to Target Workpiece

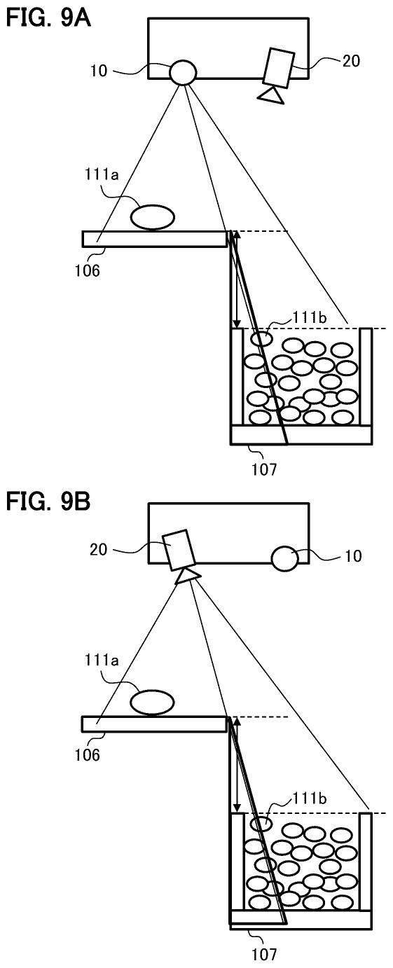

In the three-dimensional measurement system 100, a region in which the shape of the target workpiece 111 cannot be measured may be generated due to the influence of a work distance. An example thereof is illustrated in FIG. 9A and FIG. 9B. Illustrations of the positions of the projector 10 and the camera 20 relative to the target workpiece 111 are FIG. 9A and FIG. 9B. On the left side of FIG. 9A and FIG. 9B, the target workpiece 11a is placed on the belt conveyor 106. On the right side of FIG. 9A and FIG. 9B, the top portion of the bucket 107 is disposed at a position lower than the upper surface of the belt conveyor 106. The target workpiece 111b is placed in the bucket 107. Furthermore, on the left side of FIG. 9A, the projector 10 is disposed above the target workpiece 111a. On the right side of FIG. 9A, the camera 20 is disposed above the target workpiece 111b. Conversely, on the left side of FIG. 9B, the camera 20 is arranged above the target workpiece 111a. On the right side of FIG. 9B, the projector 10 is disposed above the target workpiece 111b.

On the right side of the example in FIG. 9A and FIG. 9B, the target workpiece 111b is placed in the bucket 107. The belt conveyor 106 is disposed at a position higher than the bucket 107 on the left side of the example in FIG. 9A and FIG. 9B. The target workpiece 111a is disposed on the belt conveyor 106. On the left side of the example in FIG. 9A, the projector 10 is disposed above the belt conveyor 106. On the right side of the example in FIG. 9A, the camera 20 is disposed above the bucket 107. On the other hand, on the left side of the example in FIG. 9B, the camera 20 is disposed above the belt conveyor 106. On the right side of FIG. 9B, the projector 10 is disposed above the bucket 107. On the right side of the example in FIG. 9A, irradiation light does not reach some regions in the bucket 107. Then, the camera 20 cannot capture an image of that region. Therefore, it is impossible to measure the shape of the target workpiece 111b in that region. Conversely, on the right side of the example in FIG. 9B, irradiation light reaches all the regions in the bucket 107 on the right side. However, a blind spot region of the camera 20 occurs. Then, the camera 20 cannot capture an image of that region. Therefore, it is not possible to measure the shape of the target workpiece 111b in the blind spot region of the camera 20.

In this regard, receiving irradiation light over an entire region is desirable. This entire region is captured by the two-dimensional light-receiving sensor of the camera 20. However, as illustrated in FIG. 9A, there may be the target workpiece 111 having a different work distance. Then, the irradiation light may be applied to the target workpiece 111a but not applied to the target workpiece 111b. In this case, a shadow is generated due to the irradiation light hitting the target workpiece 111a. The shadow may reach a region for the target workpiece 111b. Thus, shape measurement cannot be performed on a part of the region for the target workpiece 111b. On the contrary, even when the irradiation light reaches the entire region, the blind spot region of the camera 20 may be generated. In this case, it is not possible to measure the shape of the target workpiece 111 in the blind spot region of the camera 20. Due to the blind spot of the camera 20, a region where the shape of the target workpiece 111 cannot be measured is generated. Therefore, in the three-dimensional measurement system 100, the positions and orientations of the projector 10 and the camera 20 are ingeniously arranged. With this arrangement, it is preferable to prevent a region where the shape measurement of the target workpiece 111 is impossible from occurring.

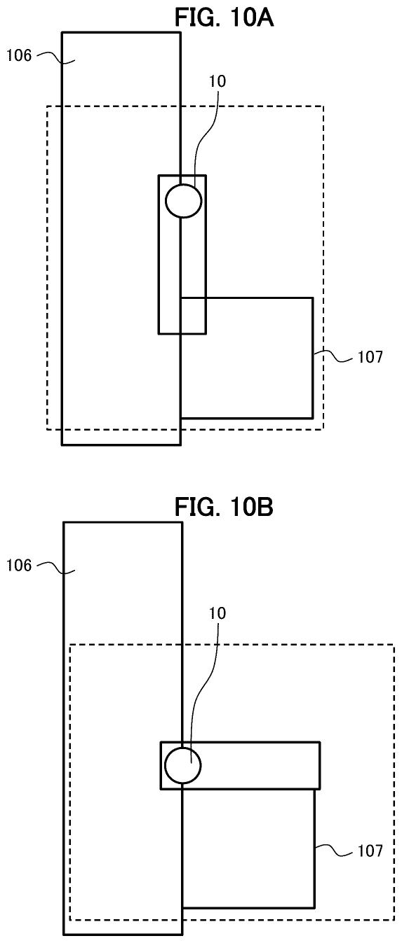

FIG. 10A and FIG. 10B are illustrations of the orientation of the projector 10. The projector 10 is a light source. In the example of FIG. 10A, the projector 10, that is, the light source is disposed above the border line of the left belt conveyor 106. The projector 10 emits light along the longitudinal direction of the belt conveyor 106, that is, along the conveyance direction. Thus, the three-dimensional measurement system 100 prevents generation of a region where the shape of the target workpiece 111 cannot be measured. Furthermore, in the example of FIG. 10B, the projector 10, that is, a light source is disposed above the border line of the belt conveyor 106 on the left side near the bucket 107 on the right side. The projector 10 emits light along the longitudinal direction of the belt conveyor 106, that is, along a direction perpendicular to the conveyance direction. Thus, the three-dimensional measurement system 100 prevents generation of a region where the shape of the target workpiece 111 cannot be measured.

In such a three-dimensional measurement system 100, when the position of the camera 20 is determined, a light source position is preferably located on a boundary line between divided regions. A light source position may be set not on a boundary line but in a region where a work distance is long, as long as it is within the angle of view at which the target workpiece 111 can be captured. At this time, since the camera 20 usually has different vertical and horizontal angles of view, it is decided whether to align the camera 20 itself parallel to the boundary line or the camera 20 itself perpendicular to the boundary line. This determination is performed according to the group of target workpieces.

In order to prevent the occurrence of a region in which the shape of the target workpiece 111 cannot be measured, the shape measurement calculation section 36 of the three-dimensional measurement system 100 may perform shape measurement at a relative position that satisfies a first condition. The first condition is that a target workpiece falls within the camera angle of view.

With the first condition as a precondition, the shape measurement calculation section 36 of the three-dimensional measurement system 100 performs shape measurement at a relative position satisfying a second condition or a third condition. The second condition is that an area in which irradiation light reaches the inside of the angle of view is 90% or more of the maximum value. The third condition is that an imaging region is 90% or more of the maximum value.

In a relative position that satisfies either the second condition or the third condition, an area of a region under one of the conditions is maximized, while an area of a region under the other condition is fixed. To be fixed means to be limited. Here, among the candidates for maximizing the area of one of the conditions, the relative position at which the area of the other condition is maximized represents a relative position that satisfies either the second condition or the third condition.

### Margin of Divided Region

In the case of determining the position of the camera 20 so as to satisfy the above-described conditions, the three-dimensional measurement system 100 basically divides regions by the boundary lines. However, when the group of target workpieces is spaced apart in the region to be divided, the three-dimensional measurement system 100 provides a margin between the divided regions. Thus, the three-dimensional measurement system 100 can secure the degree of freedom in the optimal position of the camera 20. A distance at which a shadow does not fall on the target workpiece 111 means a margin.

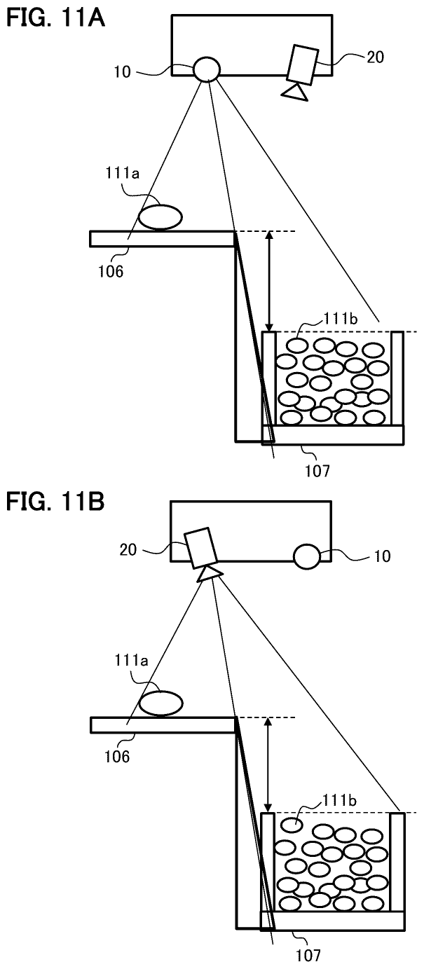

In the three-dimensional measurement system 100, the projector 10 and the camera 20 can be arranged. Examples are illustrated in FIG. 11A and FIG. 11B. FIG. 11A and FIG. 11B are illustrations of a shadow region. In FIG. 11A and FIG. 11B, the bucket 107 on the right side is disposed away from the right end of the belt conveyor 106 on the left side. This is the point of difference from FIG. 9A and FIG. 9B. In the example of FIG. 11A, even if a region where irradiation light does not reach is generated, there is no influence on shape measurement of the region of the target workpiece 111. Therefore, in the example of FIG. 11A, the degree of freedom of the camera angle of view is improved accordingly. Conversely, in the example of FIG. 11B, even if a region that is a blind spot on the observation side occurs, it does not influence shape measurement of the region of the target workpiece 111. Therefore, in the example of FIG. 11B, the flexibility of the camera angle of view is improved accordingly.

### Relationship Between Shadow Region and Margin

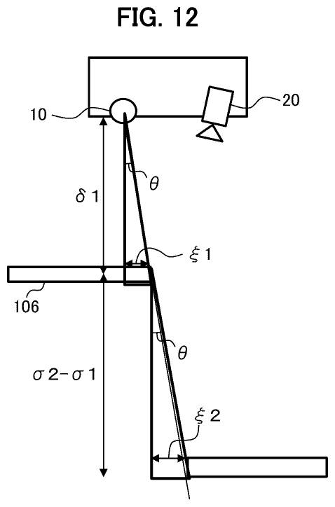

Further, for example, the three-dimensional measurement system 100 can arrange the projector 10 and the camera 20. This arrangement is illustrated in FIG. 12. FIG. 12 is an illustration of a relation between a shadow region and a margin. In the example of FIG. 12, the projector 10 is disposed at a position separated from the right end of the belt conveyor 106 to the left side by a deviation amount 1 of a light source and at a position separated upward by a work distance 61. In addition, the bucket 107 is disposed at a position separated from the right end of the belt conveyor 106 to the right side by a shadow length 2 and at a position separated downward from the camera 20 by a work distance 62.

In the example of FIG. 12, the shape measurement calculation section 36 of the three-dimensional measurement system 100 performs shape measurement within a range in which the shadow of one divided region does not affect the other divided region so as to satisfy a fourth condition on the premise of the first condition. The fourth condition is that the length ξ2 of a shadow toward a farther object be equal to or smaller than a predetermined margin.

ξ2=((δ2−σ1)/δ1)×ξ1≤Margin Fourth Condition:
Meanings of respective signs of the fourth condition are as follows.
δ1: Work Distance from Two-Dimensional Light-Receiving Sensor 21 to Near Object
δ2: Work Distance from Two-Dimensional Light-Receiving Sensor 21 to Far Object
ξ1: Deviation Amount of Light source from Edge Portion of Near Object
ξ2: Length of Shadow toward Far Object

For the three-dimensional measurement system 100, by providing a margin region between work regions, even if a shadow region or a blind spot region is generated in the margin region, a region that does not influence shape measurement of the target workpiece 111 is secured. Therefore, the three-dimensional measurement system 100 improves the degree of freedom of a camera position.

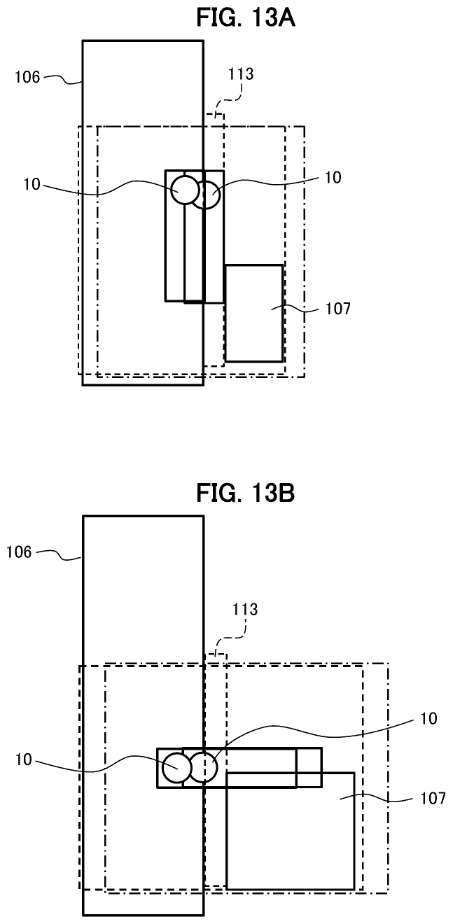

Furthermore, in the three-dimensional measurement system 100, the projector 10 and the camera 20 can be arranged such that a margin region 113 is secured. An example of this is illustrated in FIG. 13A and FIG. 13B. Diagrams illustrating a relationship between the orientation of the projector 10 and a shadow region are FIG. 13A and FIG. 13B. The projector 10 is a light source.

As illustrated in FIG. 13A and FIG. 13B, there is a certain space as the margin region 113 in a work region when viewed from directly above. In this case, based on a relationship between the position of the projector 10 and a work distance between the projector 10 and the target workpiece 111, the three-dimensional measurement system 100 can set the position of the camera 20 within a range in which a generated shadow falls within the margin region 113. The position of the projector 10 is the position of a light source. Even if the projector 10 is disposed on a boundary line of the belt conveyor 106 and a target work region does not fit in the camera angle of view, the three-dimensional measurement system 100 can adapt to such a situation by changing the position of the projector 10 to the left. This allows the three-dimensional measurement system 100 to achieve both securing an irradiation region that is not influenced by a shadow and securing a camera angle of view that accommodates a target workpiece. Since the shadow of the projector 10 does not influence the region of the target workpiece 111, the three-dimensional measurement system 100 can improve the degree of freedom of the camera angle of view. The projector 10 is a light source. Note that the method of determining a camera position in the case where a target object is fixed has been described here. However, in the three-dimensional measurement system 100, when there is a degree of freedom in the physical arrangement of the target object itself, a user may provide guidance so that the target object or the camera 20 is positioned at an optimal location.

In the coexistence production site of the conveyance form of the target workpiece 111, the three-dimensional measurement system 100 does not require a unique vision system for each application, and can be constructed as a system for recognizing an object with one vision system. The conveyance form includes a state of being randomly piled and a conveyance state by a belt conveyor or the like. Note that in a coexistence production site of the conveyance form of the target workpiece 111, the three-dimensional measurement system 100 can also be constructed as a system that recognizes an object by one camera 20 without requiring cameras 20 according to each application. The conveyance form includes a state of being randomly piled and a conveyance state by a belt conveyor.

### Operation of Three-Dimensional Measurement System

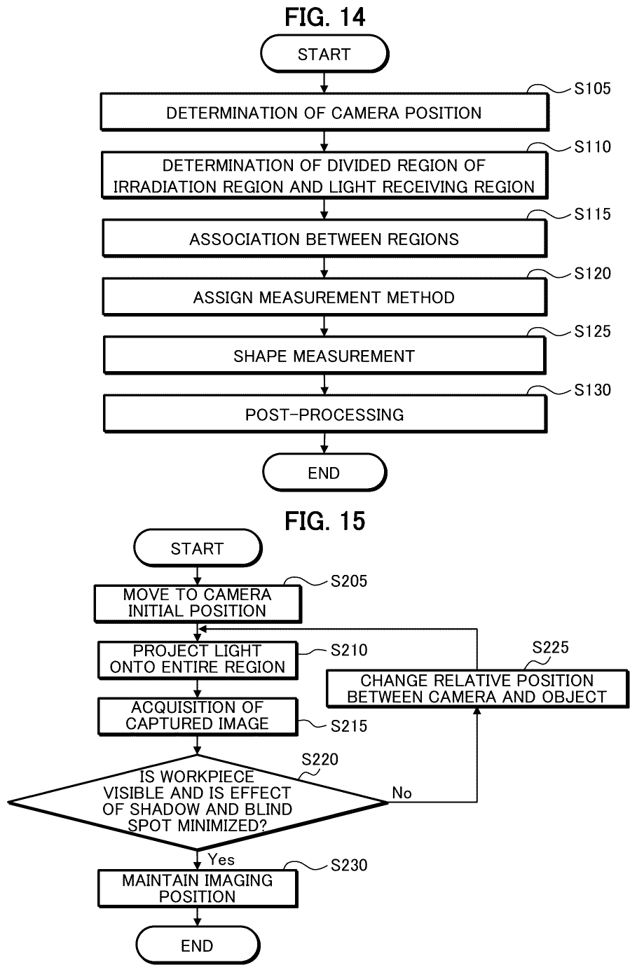

Hereinafter, an operation of the three-dimensional measurement system 100 will be described with reference to FIG. 14 to FIG. 19.

### Schematic Operation of Entire Three-Dimensional Measurement System

First, a schematic operation of the entire three-dimensional measurement system 100 will be described with reference to FIG. 14. FIG. 14 is a flowchart of a schematic operation of the entire three-dimensional measurement system 100.

As shown in FIG. 14, the three-dimensional measurement system 100 determines the position of the camera 20 by the robot arm 26. This processing is performed in step S105. The robot arm 26 is a movable portion. In step S105, in order to capture an image of the target workpiece 111, the three-dimensional measurement system 100 arranges the main body of the camera 20 at a position where irradiation light and the imaging angle of view are optimal. Note that a case where the camera 20 is fixed at an arbitrary place for use and a case where the camera 20 is attached to the robot arm 26 for use are conceivable. Here, a case where the camera 20 is used by being attached to the robot arm 26 will be described.

After step S105, the three-dimensional measurement system 100 determines divided regions in a irradiation region and an imaging region by the irradiation region division section 32 and the imaging region division section 33, and divides the irradiation region and the imaging region into two or more. This processing is performed in step S110. In step S110, when the three-dimensional measurement system 100 divides the inside of the imaging angle of view into regions, the three-dimensional measurement system 100 manually or automatically determines regions for which different shape measurement methods are used. In the case of manual operation, the three-dimensional measurement system 100 causes a user to designate a divided region via a user interface such as the input section 19. The input section 19 is illustrated in FIG. 1. In the case of automatic processing, an object on which the target workpiece 111 is placed, such as a bucket or a belt conveyor, appearing in a captured image is recognized, and divided regions are determined for each object.

After step S110, the three-dimensional measurement system 100 causes the region association section 34 to associate the divided regions in the irradiation region and the corresponding divided regions in the imaging region with each other. This processing is performed in step S115.

After step S115, the three-dimensional measurement system 100 allocates one of measurement methods to each divided region associated by the allocation section 35. This processing is performed in step S120.

After step S120, the three-dimensional measurement system 100 measures the shape of the target workpiece 111 in accordance with the measurement method allocated to each divided region by the shape measurement calculation section 36. This processing is performed in step S125. In step S125, the three-dimensional measurement system 100 projects light and receives the light with the two-dimensional light-receiving sensor 21. The three-dimensional measurement system 100 reconstructs the shape of the target workpiece 111 to a three-dimensional shape from luminance information obtained by the light reception. The two-dimensional light-receiving sensor 21 is shown in FIG. 1.

After step S125, the three-dimensional measurement system 100 performs post-processing by the post-processing section 50. This processing is performed in step S130. The present embodiment will be described assuming that, as the post-processing in step S130, there are a case where the shape inspection of the target workpiece 111 is performed and a case where the picking of the target workpiece 111 is performed. Here, picking means gripping. The three-dimensional measurement system 100 changes information to be output to the outside according to the content of the post-processing. When the shape inspection of the target workpiece 111 is performed, the three-dimensional measurement system 100 outputs the shape determination information of the target workpiece 111 to the outside. On the other hand, when the target workpiece 111 is picked, the three-dimensional measurement system 100 outputs gripping information of the target workpiece 111 to the outside. Here, picking means gripping. The gripping information includes position and orientation information, gripping position information, and the like.

### Processing for Determining Camera Position

Next, the processing of step S105 in FIG. 14 will be described with reference to FIG. 15. This processing is processing for determining a camera position. An outline of the overall operation of the three-dimensional measurement system 100 will be described. The flowchart of FIG. 15 illustrates an operation of determining the camera angle of view of the three-dimensional measurement system 100.

As shown in FIG. 15, the three-dimensional measurement system 100 moves the camera 20 to the initial position by the robot arm 26. This processing is performed in step S205. The camera 20 must be mounted on the robot arm 26 as a prerequisite for step S205. In a case where the camera 20 is fixed, a relative position between the camera 20 and the target workpiece 111 is changed by manually changing the position of the camera 20 or manually changing the position of the target workpiece 111.

After step S205, the three-dimensional measurement system 100 projects light onto the entire irradiation region. This processing is performed in step S210. In step S210, the projector 10 which is a light source-side projects a projection pattern in an arbitrary shape so that the camera 20 which is an image capture side can capture an image.

After step S210, the three-dimensional measurement system 100 acquires a captured image with the camera 20. This processing is performed in step S215.

After step S215, the three-dimensional measurement system 100 determines, based on the captured image, whether the target workpiece 111, which is a workpiece to be measured, is visible and the influence of a shadow or a blind spot is minimized. This processing is performed in step S220. The determination in step S220 is performed by detecting, based on the captured image, whether there is a shadow or a blind spot and there is a region where light cannot be received even in a case where there is no shadow or blind spot. At that time, a user may be allowed to confirm these via the user interface. Alternatively, these may be automatically determined on the basis of information on the arrangement position of a structure and a work distance which are known in advance.

In the determination of step S220, when it is determined that the target workpiece 111 which is a workpiece to be measured is not reflected or the influence of a shadow or a blind spot is not minimized, that is, in the case of “No”, the three-dimensional measurement system 100 changes a relative position between the camera 20 and the target workpiece 111. This processing is performed in step S225. Thereafter, the processing returns to step S210. The three-dimensional measurement system 100 changes a relative position between the camera 20 and the target workpiece 111 until an appropriate camera position is reached, and repeats the processing from step S210 to step S225.

On the other hand, in the determination in step S220, if it is determined that the target workpiece 111 as a workpiece to be measured is captured and the influence of a shadow or a blind spot is minimized, that is, in the case of “Yes”, the three-dimensional measurement system 100 holds the imaging position. This processing is performed in step S230.

Processing for Determining Divided Region in Irradiation Region and Imaging Region and Processing for Associating Region with Each Other

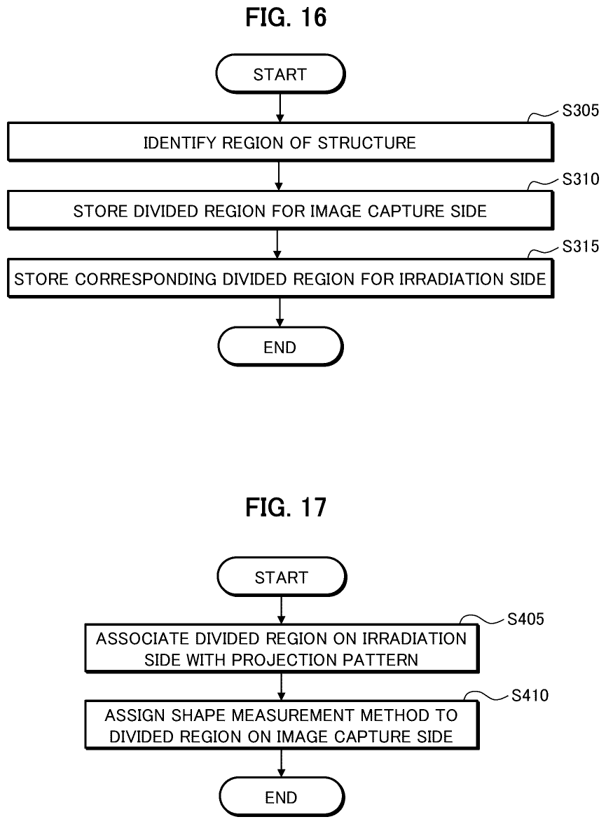

Next, with reference to FIG. 16, the processing of step S110 and the processing of step S115 in FIG. 14 will be described. The processing of step S110 is processing of determining divided regions in an irradiation region and an imaging region. The processing of step S115 is association processing between regions. The flowchart of FIG. 16 illustrates an operation of determining divided regions by the three-dimensional measurement system 100.

As illustrated in FIG. 16, the three-dimensional measurement system 100 identifies a region of a structure appearing in a captured image. This processing is performed in step S305. In step S305, a region in which a belt conveyor, a bucket, or the like appears as a structure is identified. Conceivable methods for identifying the region include a method in which a user is allowed to specify the region through a user interface such as the input section 19 in FIG. 1, a method in which the three-dimensional measurement device 30 automatically recognizes a structure by a known method to identify the region, and the like.

After step S305, the three-dimensional measurement system 100 determines divided regions in an irradiation region and an imaging region, and associates the divided regions in the irradiation region and the corresponding divided regions in the imaging region with each other. Then, the three-dimensional measurement system 100 stores the imaging region information 71 regarding the divided region information of the imaging region in the storage section 70. This processing is performed in step S310. The storage section 70 and the imaging region information 71 are shown in FIG. 1. The three-dimensional measurement system 100 stores, in the storage section 70, the projection region information 72 regarding the divided region information in the irradiation region that is the corresponding irradiation side. This processing is performed in step S315. However, the processing of step S310 may be performed before the processing of step S310. The storage section 70 and the projection region information 72 are illustrated in FIG. 1.

In step S315, the three-dimensional measurement system 100 identifies a region in which a structure such as a belt conveyor or a bucket appears, finally divides the captured image into regions according to a structure, and stores the divided regions in the storage section 70. Further, in step S315, corresponding divided region information on the irradiation side is determined from the divided region information on the image capture side, and the divided region information is stored in the storage section 70. Thus, the three-dimensional measurement system 100 matches the divided regions on the irradiation region side, which is the irradiation side, with the divided regions on the image capture side.

### Measurement Method Allocation Processing

Next, referring to FIG. 17, the processing in step S120 in FIG. 14, that is, the measurement method allocation processing will be described. The flowchart of FIG. 17 illustrates a measurement method allocation operation of the three-dimensional measurement system 100.

As shown in FIG. 17, the three-dimensional measurement system 100 determines one pattern to be projected for each divided region on the irradiation region side which is the irradiation side, and associates the divided region on the irradiation region side which is the irradiation side with the projection pattern. This processing is performed in step S405. Further, the three-dimensional measurement system 100 determines one shape measurement method to be allocated to the divided region on the image capture side, and allocates the shape measurement method to the divided region on the image capture side. This processing is performed in step S410. These pieces of information are held in the storage section 70. Then, at the time of execution of the shape measurement processing in step S125 of FIG. 14, these pieces of information are referred to by the shape measurement calculation section 36.

### Shape Measurement Process

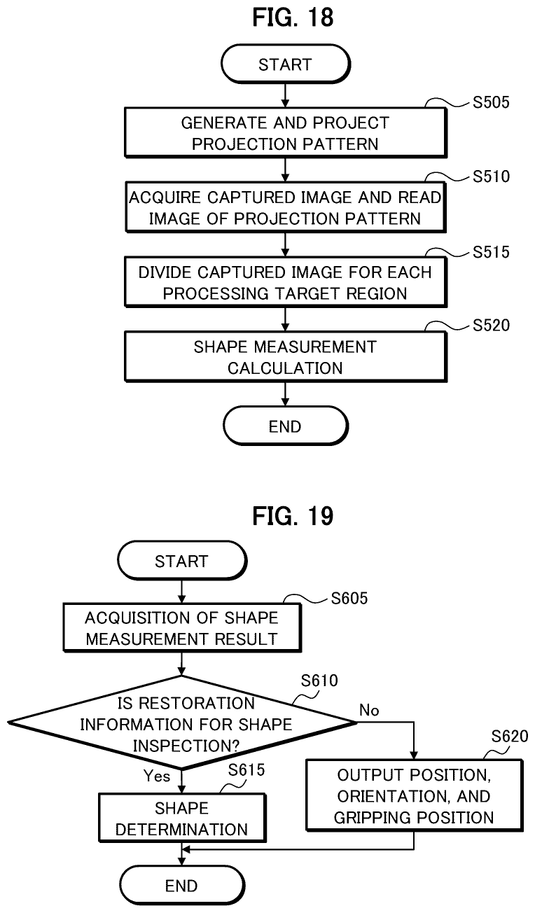

Next, the process of step S125 in FIG. 14, that is, the shape measurement process will be described with reference to FIG. 18. The flowchart of FIG. 18 illustrates a shape measurement operation of the three-dimensional measurement system 100.

As illustrated in FIG. 18, in the three-dimensional measurement system 100, the irradiation region division section 32 generates a projection pattern, and the projection controller 51 controls the projector 10 to project the projection pattern. This processing is performed in step S505. The projector 10 is a light source. In step S505, the three-dimensional measurement system 100 determines, from the information stored in the storage section 70, a projection pattern in accordance with a measurement method allocated to each divided region on the image capture side. Next, the three-dimensional measurement system 100 integrates the projection patterns to generate one projection pattern for the entire region. In the three-dimensional measurement system 100, the projection controller 51 controls the projector 10 to project the projection pattern for the entire region onto the target workpiece 111 or the like.

After step S505, the three-dimensional measurement system 100 causes the imaging controller 52 to control the camera 20 to acquire a captured image, and causes the object recognition section 40 to read an image of the projection pattern from the captured image. This processing is performed in step S510. In step S510, the three-dimensional measurement system 100 receives light of the projection pattern for the entire region with the camera 20 and acquires brightness information.

In steps S505 and S510, the three-dimensional measurement system 100 needs to switch projection patterns multiple times depending on a measurement method. Therefore, the three-dimensional measurement system 100 acquires desired luminance information by synchronizing the projection controller 51 and the imaging controller 52 with each other.

After step S510, the three-dimensional measurement system 100 divides the captured image for each processing target region by the allocation section 35. This processing is performed in step S515. In step S515, the three-dimensional measurement system 100 determines a shape measurement target region based on the imaging region held in the storage section 70.

After step S515, the three-dimensional measurement system 100 calculates, by the shape measurement calculation section 36, shape measurement of the target workpiece 111 for each divided region. This processing is performed in step S520. In step S520, the three-dimensional measurement system 100 measures the shape of the target workpiece 111 using a different shape measurement method for each divided region.

Such a three-dimensional measurement system 100 can satisfactorily measure the shape of the target workpiece 111 using known measurement methods for each divided region on the image capture side. The known measurement methods include a phase shift method, a light section method, and a spatial coding method.

### Post-Processing

Next, the processing of step S130 in FIG. 14 will be described with reference to FIG. 19. The processing of step S130 is post-processing. The flowchart of FIG. 19 illustrates an post-processing operation of the three-dimensional measurement system 100.

As illustrated in FIG. 19, the three-dimensional measurement system 100 acquires three-dimensional restoration information as a shape measurement result of the target workpiece 111. This processing is performed in step S605.

After step S605, the three-dimensional measurement system 100 identifies the intended use of the three-dimensional restoration information acquired in step S605. Then, the three-dimensional measurement system 100 determines whether the restoration information is for shape inspection. This processing is performed in step S610. The description herein is given on the assumption that the intended use of the restoration information is one of shape inspection of the target workpiece 111 and picking of the target workpiece 111. Picking means gripping.

In the determination in step S610, when it is determined that the intended use of the restoration information is the shape inspection of the target workpiece 111, that is, in the case of “Yes”, the three-dimensional measurement system 100 determines the shape of the target workpiece 111. This processing is performed in step S615. In this case, the three-dimensional measurement system 100 outputs the shape determination information of the target workpiece 111 to the outside. On the other hand, in the determination in step S610, if it is determined that the intended use of the restoration information is not the shape inspection of the target workpiece 111, that is, in the case of “No”, the three-dimensional measurement system 100 performs picking of the target workpiece 111. This processing is performed in step S620. In this case, the three-dimensional measurement system 100 acquires the gripping information of the target workpiece 111 by general three-dimensional matching processing or the like and outputs the gripping information of the target workpiece 111 to the outside. Picking means gripping. The gripping information of the target workpiece 111 includes position and orientation information, gripping position information, and the like.

In a case where the three-dimensional measurement system 100 includes cameras, the three-dimensional measurement system 100 performs shape measurement in consideration of allocation of divided regions and cameras. For example, the three-dimensional measurement system 100 allocates a short-range camera and a long-range camera according to workpiece groups having different work distances. In a case where the work distance of workpieces randomly piled increases and the work distance exceeds a certain threshold value during a picking operation, shape measurement by the long-range camera is also conceivable. The three-dimensional measurement system 100 prevents one region from interfering with the other region by providing a margin at a boundary between projection patterns. Furthermore, the three-dimensional measurement system 100 determines a camera position that minimizes the influence of a shadow or a blind spot in consideration of a difference in the work distance of target workpieces.

### Principal Features of Three-Dimensional Measurement System, Three-Dimensional Measurement Method, and Non-Transitory Computer-Readable Storage Medium Storing Program Storing Program

The three-dimensional measurement system 100 according to the present embodiment can have the following features.

(1) The three-dimensional measurement system 100 according to the present embodiment is a system, and the three-dimensional measurement system 100 according to the present embodiment measures the three-dimensional shape of a target workpiece by capturing an irradiation region irradiated with light in a predetermined pattern and having a predetermined area with the two-dimensional light-receiving sensor 21. As illustrated in FIG. 1, the three-dimensional measurement system 100 includes the irradiation region division section 32, the imaging region division section 33, the region association section 34, the allocation section 35, and the shape measurement calculation section 36. The irradiation region division section 32 is a constituent element, and the irradiation region division section 32 divides an irradiation region into two or more, and irradiates the divided irradiation regions with irradiation light in respectively different patterns. The imaging region division section 33 is a constituent element, and the imaging region division section 33 divides an imaging region into two or more. The region association section 34 is a constituent element and associates corresponding divided regions between the irradiation region and the imaging region. The allocation section 35 is a constituent element that allocates one of measurement methods to each of the associated divided regions. The shape measurement calculation section 36 is a constituent element, and measures the shape of each target workpiece by a measurement method allocated to its divided region.

In the three-dimensional measurement system 100 according to the present embodiment, the shape measurement calculation section 36 measures the shape of a target workpiece in accordance with a measurement method allocated to each divided region. Even under an environment in which production forms are aggregated and mixed, the three-dimensional measurement system 100 according to the present embodiment as described above suitably measures the shape of the target workpiece 111. Furthermore, the three-dimensional measurement system 100 divides an image of one angle of view captured by one camera 20 into regions. Thus, the three-dimensional measurement system 100 can perform shape measurement as if processing based on images with angles of view captured by cameras 20. Therefore, in a case where the shape of the target workpiece 111 is to be measured by using a different measurement methods in the three-dimensional measurement system 100, it is not necessary to prepare images with camera angles of view captured by cameras 20. In addition, the three-dimensional measurement system 100 does not needs to change the specifications of the system for each production system that changes in various ways. Therefore, the three-dimensional measurement system 100 can measure the shape of the target workpiece 111 by a general-purpose single system. In addition, the three-dimensional measurement system 100 does not need to prepare each facility for a production site. Therefore, production processes are aggregated, and the efficiency of occupied area is achieved.

(2) As illustrated in FIG. 2, in the three-dimensional measurement system 100 according to the above (1), the allocation section 35 allocates an arbitrary measurement method to each of the divided regions, thereby making it possible to simultaneously use different measurement methods for the respective divided regions in response to the states of the target workpieces.

The three-dimensional measurement system 100 according to the present embodiment can simultaneously use different measurement methods in accordance with the states of the target workpieces 111.

(3) As illustrated in FIG. 5, in the three-dimensional measurement system 100 according to the above (1), each divided region within the imaging region is allocated two or more different measurement methods.

The three-dimensional measurement system 100 according to the present embodiment can simultaneously use two or more different measurement methods.

(4) As illustrated in FIG. 1, the three-dimensional measurement system 100 according to the above (1) includes an image capturing section, an image display part, and the input section 19. The image capturing section is a constituent element and captures an image by independently operating the two-dimensional light-receiving sensor 21 that receives light. The image display part is a constituent element and displays the image captured by the image capturing section. The input section 19 is a constituent element and receives an instruction from a user. Regarding the irradiation region division section 32 and the imaging region division section 33, in response to a user's instruction received by the input section 19, the irradiation region division section 32 can determine a divided region in an irradiation region and the imaging region division section 33 can determine a divided region in an imaging region. The image capturing section is the camera 20. The image display part is the display 18.

The three-dimensional measurement system 100 according to the present embodiment can determine a divided region in response to an instruction from a user and measure the shape of the target workpiece 111.

(5) As illustrated in FIG. 1, the three-dimensional measurement system 100 according to the (1) further includes the object recognition section 40. The object recognition section 40 recognizes the shape of a target object appearing in a captured image. According to the recognition result of the target object, the irradiation region division section 32 can identify a divided region in an irradiation region, and the imaging region division section 33 can identify a divided region in a light receiving region.

The three-dimensional measurement system 100 according to the present embodiment can identify a divided region in an irradiation region and a divided region in a light receiving region in response to a recognition result of a target object and measure the shape of the target workpiece 111.

(6) As illustrated in FIG. 1, the three-dimensional measurement system 100 according to the above (1) includes the object height identification section 41, the position identification section 42, and a shadow region identification section 43. The object height identification section 41 is a constituent element, and the object height identification section 41 identifies the heights of target objects in the same angle of view. The position identification section 42 is a constituent element, and the position identification section 42 identifies a relative position between irradiation light and a boundary between divided regions. The shadow region identification section 43 is a constituent element. The shadow region identification section 43 identifies a shadow region in one divided region at which a height is greater than a height at another divided region adjacent to the one divided region. The shape measurement calculation section 36 performs shape measurement at a relative position satisfying the following first condition. The first condition is that a target workpiece falls within the camera angle of view.

The three-dimensional measurement system 100 according to the present embodiment performs shape measurement at a relative position satisfying the first condition. Thus, the three-dimensional measurement system 100 according to the present embodiment can perform suitable shape measurement of the target workpiece 111.

(7) In the three-dimensional measurement system 100 according to the above (6), the shape measurement calculation section 36 performs shape measurement, with the first condition as a precondition, at a relative position satisfying the following second condition or the following third condition. The second condition is that an area of a region where irradiation light reaches within the angle of view is greater than or equal to 90% of a maximum area of an irradiation-enabled region. The third condition is that the area of an imaging region is equal to or larger than 90% of the maximum area that can be imaged.

The three-dimensional measurement system 100 according to the present embodiment performs shape measurement, with the first condition as a precondition, at a relative position satisfying the second condition or the third condition. Thus, the three-dimensional measurement system 100 according to the present embodiment can perform suitable shape measurement of the target workpiece 111.

(8) As shown in FIG. 12, the three-dimensional measurement system 100 according to the above (6) further includes the distance identification section 44. The distance identification section 44 identifies a physical distance between objects existing within the same angle of view. With the first condition as a precondition, the shape measurement calculation section 36 performs shape measurement within a range in which the shadow of one divided region does not influence the other divided region so as to satisfy the following fourth condition. The fourth condition is that the length of the shadow of an object having a long working distance from the two-dimensional light-receiving sensor 21 to the object is equal to or less than a predetermined margin.

The three-dimensional measurement system 100 according to the present embodiment performs shape measurement, with the first condition as a precondition, at a relative position satisfying the fourth condition. Thus, the three-dimensional measurement system 100 according to the present embodiment can perform suitable shape measurement of the target workpiece 111.

(9) As illustrated in FIG. 8B, in the three-dimensional measurement system 100 according to the above (1), the irradiation region division section 32 recognizes a work region and does not form an irradiation pattern in a certain region at a boundary part thereof.

The three-dimensional measurement system 100 according to the present embodiment does not form an irradiation pattern in a certain area at a boundary portion in a work region. As a result, the three-dimensional measurement system 100 according to the present embodiment can prevent interference between an irradiation region and a light receiving region.

(10) As shown in FIG. 1, the three-dimensional measurement system 100 according to the above (1) includes the divided region display controller 46 and the method candidate display controller 47. The divided region display controller 46 is a constituent element, and the divided region display controller 46 displays divided regions on the display 18 in a selectable manner. The method candidate display controller 47 is a constituent element, and the method candidate display controller 47 displays candidates of shape measurement methods on the display 18 in a selectable manner. The allocation section 35 allocates a shape measurement method to a divided region in response to an instruction from a user.

The three-dimensional measurement system 100 according to the present embodiment causes a user to designate a suitable shape measurement method from among shape measurement method candidates displayed on the display 18 in a selectable manner. The three-dimensional measurement system 100 according to the present embodiment can allocate a suitable shape measurement method to a divided region. An instruction from a user means designation of a shape measurement method.

(11) In the three-dimensional measurement system 100 according to the above (5), the object recognition section 40 estimates an object attribute of a divided region. The allocation section 35 allocates a measurement method to a divided region in accordance with an estimation result of an object attribute.

The three-dimensional measurement system 100 according to the present embodiment estimates an object attribute of a divided region. The three-dimensional measurement system 100 according to the present embodiment can allocate a measurement method to a divided region in response to the estimation result of an object attribute.

(12) The three-dimensional measurement system 100 according to the above (5) includes the imaging controller 52 that switches between the two-dimensional light-receiving sensors 21. The imaging controller 52 switches between the two-dimensional light-receiving sensors 21. The object recognition section 40 identifies a difference in height between divided regions. The imaging controller 52 selects, for each divided region, the two-dimensional light-receiving sensor 21 which is capable of being focused on the target workpiece 111, which is a workpiece.

The three-dimensional measurement system 100 according to the present embodiment determines a difference in height between divided regions. The three-dimensional measurement system 100 according to the present embodiment selects, for each divided region, the two-dimensional light-receiving sensor 21 that is capable of being focused on the workpiece in response to a difference in height. Such a three-dimensional measurement system 100 can automatically select a suitable two-dimensional light-receiving sensor 21. Therefore, such a three-dimensional measurement system 100 can improve accuracy in measuring the shape of the target workpiece 111.

(13) The three-dimensional measurement system 100 according to the above (6) includes the imaging controller 52. The imaging controller 52 switches between the two-dimensional light-receiving sensors 21. The object height identification section 41 detects a change in the height of an object. When the height becomes equal to or more than a predetermined distance or equal to or less than the predetermined distance, the imaging controller 52 switches to the two-dimensional light-receiving sensor 21 which is capable of being focused on the target workpiece 111, which is a workpiece.

When the height of an object is equal to or more than a predetermined distance or equal to or less than the predetermined distance, the three-dimensional measurement system 100 according to the present embodiment selects the two-dimensional light-receiving sensor 21 that is capable of being focused on the workpiece. Such a three-dimensional measurement system 100 can automatically select a suitable two-dimensional light-receiving sensor 21. Therefore, such a three-dimensional measurement system 100 can improve accuracy in measuring the shape of the target workpiece 111.

(14) As illustrated in FIG. 1, the three-dimensional measurement system 100 according to the above (1) includes the storage section 70 and the content display controller 48. The storage section 70 stores the association information 74 between a divided region and a measurement method. The content display controller 48 displays the content of the stored association information 74. In response to a user's instruction, the region association section 34 updates the content of the association information 74 stored in the storage section 70.

The three-dimensional measurement system 100 according to the present embodiment updates the content of the association information 74 stored in the storage section 70 in response to a user's instruction. Such a three-dimensional measurement system 100 can arbitrarily update the content of the association information 74 in response to the operation.

(15) In the three-dimensional measurement system 100 according to the above (5), the object recognition section 40 detects that a target object has moved during system operation. The region association section 34 newly sets a divided region by identifying a region to which the target object has moved.

When the target workpiece 111, which is a target object, moves during system operation, the three-dimensional measurement system 100 according to the present embodiment can newly set a divided region. Even when a target object moves, such a three-dimensional measurement system 100 can satisfactorily measure the shape of the target object.

(16) As illustrated in FIG. 14, the three-dimensional measurement method according to the present embodiment includes steps S110, S115, S120, and S125. Processing of dividing an irradiation region into two or more and irradiating each of the divided irradiation regions with irradiation light in a different pattern is performed in step S110. This processing is performed in step S505 in FIG. 18. In addition, processing for dividing an imaging region into two or more is performed in step S110. This processing is performed in step S515 in FIG. 18. Processing for associating divided regions corresponding to each other between the irradiation region and the imaging region is performed in step S115. Processing for allocating one of measurement methods to each of the associated divided regions is performed in step S120. Processing for shape measurement of each target workpiece by a measurement method allocated to its divided region is performed in step S125.

In the three-dimensional measurement method according to the present embodiment, in step S125, the shape of a target workpiece is measured by a measurement method allocated to its divided region. Even in an environment in which production forms are aggregated and mixed, such a three-dimensional measurement method according to the present embodiment suitably measures the shape of the target workpiece 111.

(17) As shown in FIG. 14, the control program 30pr according to the present embodiment causes a computer to perform the procedure of steps S110, S115, S120, and S125. Processing of dividing an irradiation region into two or more and irradiating each of the divided irradiation regions with irradiation light in a different pattern is performed in step S110. This processing is performed in step S505 in FIG. 18. In addition, processing for dividing an imaging region into two or more is performed in step S110. This processing is performed in step S515 in FIG. 18. Processing for associating divided regions corresponding to each other between the irradiation region and the light receiving region is performed in step S115. Processing for allocating one of measurement methods to each of the associated divided regions is performed in step S120. In step S125, processing for shape measurement of each target workpiece is performed by a measurement method allocated to its divided region.

The control program 30pr according to the present embodiment can realize the three-dimensional measurement system 100 according to the present embodiment.

As described above, the three-dimensional measurement system 100 according to the present embodiment can appropriately measure the shape of a target workpiece even in an environment in which production forms are intensively mixed.

Although embodiments of the present invention have been described and illustrated in detail, the disclosed embodiments are made for purposes of illustration and example only and not limitation. The scope of the present invention should be interpreted by terms of the appended claims.

What is claimed is:

1. A three-dimensional measurement system to measure a three-dimensional shape of a target workpiece by capturing an irradiation region which is irradiated in a predetermined pattern and has a predetermined area by a two-dimensional light-receiving sensor, the three-dimensional measurement system comprising:
an irradiation region division section to divide the irradiation region into two or more regions and to irradiate each of the two or more regions with irradiation light in a different pattern;
an imaging region division section to divide an imaging region into two or more regions;
a region association section to associate a divided region in the imaging region with a corresponding region obtained by division of the irradiation region;
an allocation section to allocate one measurement method from among measurement methods to each of divided regions in the imaging region, the divided regions each being associated with a corresponding one of regions obtained by division of the irradiation region; and
a shape measurement calculation section to measure a shape of each of target workpieces by a measurement method allocated to a corresponding one of the divided regions in the imaging region.

2. The three-dimensional measurement system according to claim 1, wherein
the allocation section allocates any measurement method to each of the divided regions in response to a state of a corresponding one of target workpieces so as to enable simultaneous use of different measurement methods for respective ones of the divided regions.

3. The three-dimensional measurement system according to claim 1, wherein
two or more different measurement methods are associated to each of the divided regions in the imaging region.

4. The three-dimensional measurement system according to claim 1, further comprising:
an image capturing section to capture an image by independently operating a two-dimensional light-receiving sensor to receive light;
an image display part to display an image captured by the image capturing section; and
an input section to receive an instruction from a user, and wherein the irradiation region division section determines a divided region in the irradiation region in response to an instruction from a user, and the imaging region division section determines a divided region in the imaging region in response to the instruction.

5. The three-dimensional measurement system according to claim 1, further comprising:
an object recognition section to recognize a shape of a target object appearing in a captured image; and wherein
the irradiation region division section identifies a divided region in the irradiation region in response to a recognition result, and the imaging region division section identifies a divided region in the imaging region in response to the recognition result.

6. The three-dimensional measurement system according to claim 1, further comprising:
an object height identification section to identify a height of each of target objects within the same angle of view;
a position identification section to identify a relative position between irradiation light and a boundary between the divided regions; and
a shadow region identification section to identify a shadow region in a first divided region at which a height is greater than a height at a second divided region adjacent to the first divided region, and wherein
the shape measurement calculation section performs shape measurement at a relative position satisfying a first condition in which a target workpiece is within a camera angle of view.

7. The three-dimensional measurement system according to claim 6, wherein
the shape measurement calculation section performs shape measurement, with the first condition as a precondition, at a relative position satisfying a second condition in which an area of a region in which irradiation light reaches within an angle of view is equal to or greater than 90% of a maximum area of an irradiation-enabled region or a third condition in which an area of an imaging region is equal to or greater than 90% of a maximum area of an imaging-enabled region.

8. The three-dimensional measurement system according to claim 6, further comprising:
a distance identification section to identify a physical distance between objects existing within the same angle of view, and wherein
the shape measurement calculation section performs shape measurement, with the first condition as a precondition, in a range in which a shadow of a third divided region does not influence a fourth divided region so as to satisfy a fourth condition in which a length of a shadow toward one object having a first working distance which is longer than a second working distance of another object is equal to or less than a predetermined margin, the first working distance being from the one object to the two-dimensional light-receiving sensor, and the second working distance being from the another object to the two-dimensional light-receiving sensor.

9. The three-dimensional measurement system according to claim 1, wherein
the irradiation region division section recognizes a work region and does not form an irradiation pattern in a predetermined region located at a boundary portion in the work region.

10. The three-dimensional measurement system according to claim 1, further comprising:
a divided region display controller to display the divided region; and
a method candidate display controller to display a candidate for a shape measurement method, and wherein
the allocation section allocates a shape measurement method to the divided region in response to an instruction from a user.

11. The three-dimensional measurement system according to claim 5, wherein
the object recognition section estimates an object attribute of the divided region, and
the allocation section allocates a measurement method to the divided region in response to an estimation result of an object attribute.

12. The three-dimensional measurement system according to claim 5, further comprising:
an imaging controller to switch between a first two-dimensional light-receiving sensor and a second two-dimensional light-receiving sensor, wherein
the object recognition section identifies a difference in height between divided regions, and
the imaging controller selects the first two-dimensional light-receiving sensor that is focused on a first workpiece for a first divided region corresponding to the first workpiece and the imaging controller selects the second two-dimensional light-receiving sensor that is focused on a second workpiece for a second divided region corresponding to the second workpiece.

13. The three-dimensional measurement system according to claim 6, further comprising:
an imaging controller to switch between two-dimensional light-receiving sensors, wherein
the object height identification section detects a variation in height of an object, and
the imaging controller switches to a two-dimensional light-receiving sensor that is focused on a workpiece when a height becomes equal to or greater than a predetermined distance or equal to or less than the predetermined distance.

14. The three-dimensional measurement system according to claim 1, further comprising:
a storage section to store association information between the divided region and a measurement method; and
a content display controller to display a content of stored association information, and wherein
the region association section updates a content of stored association information in response to an instruction from a user.

15. The three-dimensional measurement system according to claim 5, wherein
the object recognition section detects a movement of a target object during system operation, and
the region association section newly sets a divided region by identifying a region in which a target object is located after a movement of the target.

16. A three-dimensional measurement method comprising:
dividing an irradiation region into two or more regions;
irradiating each of the two or more regions with irradiation light in a different pattern;
dividing an imaging region into two or more regions;
associating a divided region in the imaging region with a corresponding region obtained by division of the irradiation region;
allocating one measurement method from among measurement methods to each of divided regions in the imaging region, the divided regions each being associated with a corresponding one of regions obtained by division of the irradiation region; and
measuring a shape of each of target workpieces by a measurement method allocated to a corresponding one of the divided regions in the imaging region.

17. A non-transitory computer-readable storage medium storing a program causing a computer to perform:
dividing an irradiation region into two or more regions;
irradiating each of the two or more regions with irradiation light in a different pattern;
dividing an imaging region into two or more regions;
associating a divided region in an irradiation region with a corresponding divided region in a light receiving region;
allocating one measurement method from among measurement methods to each of associated divided regions; and
measuring a shape of each of target workpieces by a measurement method allocated to a corresponding one of divided regions.
